(19) United States
(12) Patent Application Publication
(10) Pub. No.: US 2004/0030652 A1
(43) Pub. Date: Feb. 12, 2004

(54) Method for securing digital goods on sale thereof over a computer network

(76) Inventors: Stefan Grunzig, Kranzberg (DE); Tschangiz Schevbani, Munchen (DE)

Correspondence Address: BACON & THOMAS, PLLC, 625 SLATERS LANE, FOURTH FLOOR, ALEXANDRIA, VA, 22314

(21) Appl. No.: 10/362,215

(22) PCT Filed: Sep. 4, 2001
(86) PCT No.: PCT/EP01/10171

(30) Foreign Application Priority Data
Sep. 6, 2000 (DE) 100 44 139.4

(51) Int. Cl. G06F 17/60

(52) U.S. Cl. 705/51

(57) ABSTRACT

A method for protecting digital goods upon sale over a computer network is described whereby the goods are encrypted using a symmetric encryption method with a key, the encrypted goods are transmitted over the computer network to a customer's computer and decrypted there by the key. The key is transmitted separately to the customer's mobile communication terminal over a mobile phone network.

This invention relates to a method for protecting digital goods upon sale over a computer network, for example the Internet or a large in-house Intranet, whereby the goods are encrypted using a symmetric encryption method with a key, the encrypted goods are transmitted to a customer's computer over the computer network and decrypted there by means of the key.

Digital and digitizable goods such as documents, music or software can be easily purchased nowadays in so-called Internet shops. These goods are not only ordered over the Internet but can also be delivered to the customer directly over the Internet by being downloaded to the customer's computer. To ensure payment of the goods for the merchant, the goods are normally downloaded to the customer's computer from the server only after a credit card number is entered. Payment is then made via the customer's corresponding credit card. The credit card number must either be stated to the particular merchant once upon registration at the customer's first purchase, or it is asked for anew at every purchase. Since in particular the Internet is a relatively transparent, unprotected network, it cannot be ruled out that the customer's credit card number and address become known to unauthorized third parties during transmission and can then be abused. This deters many potential users from using Internet shops.

U.S. Pat. No. 5,809,144 proposes a method for selling and delivering digital goods over the Internet whereby the goods are delivered to customers in encrypted form and, after a corresponding, likewise encrypted payment order, the key required for decrypting the digital goods is transmitted to the customer by the same route. The customer can then use this key to decrypt the goods. Since the same key is used for encryption and for decryption, this is a so-called symmetric encryption method. For mutually protecting the customer and the merchant and protecting the key during transmission, an extremely elaborate and computing-intensive method is proposed here that includes not only transmission of several cryptographic checksums but also a signature. Thus, the implementation of the method also requires the services of a trust center.

For general payment of goods it is furthermore known for the merchant to contact a special service operator that effects the payment transaction, and this service operator to then call a mobile phone of the customer who confirms payment of the amount to be paid by means of his mobile phone. After receiving the confirmation the merchant receives a corresponding communication from the service operator and thereupon releases the goods (“Kampfansage an Kreditkarte”, Wirtschaftswoche, Mar. 23, 2000). This method offers the advantage that the payment process is not effected online but over a second network system. However, it is not suitable for encrypting digital goods to be transmitted over the Internet. In this method the goods are transmitted over the Internet unencrypted so that this method does not prevent the goods from becoming available to unauthorized third parties who can then utilize the goods.

It is the problem of the present invention to provide an alternative to the stated prior art that makes it possible to protect digital goods upon sale over a computer network in simple and safe fashion.

This problem is solved by a method according to claim 1. The dependent claims contain advantageous developments and embodiments of the inventive method.

In the inventive method, the goods are encrypted using a symmetric encryption method and these encrypted goods transmitted to the customer's computer. Transmission of the key is effected by a completely independent route, namely over a mobile phone network to the customer's mobile communication terminal. The mobile phone network can be any mobile phone network, for example GSM or UMTS. The term “mobile phone network” used here also includes corresponding pager networks. The mobile communication terminal is for example a commercial mobile phone or pager.

Transmission of cryptogram and key by different routes guarantees extremely high security. Therefore, it is possible to use a symmetric algorithm in encrypting the goods. Relatively simple session keys (TAN, transaction number) can be employed here, which are only used once for a transmission. The use of a symmetric algorithm with simple session keys keeps computation times low during encryption and decryption.

Preferably, before a first purchase the customer registers with a service operator, transmitting to the service operator an identification feature that is uniquely linked with the user's mobile communication terminal. This identification feature is preferably the mobile phone number of the mobile phone or the subscriber number of the pager or another registration number associated with said devices. The thus registered customer is then preferably assigned a personal identification number, i.e. a PIN, for utilizing the service. This personal identification number is likewise transmitted to the mobile communication terminal over the mobile phone network. Transmission of the PIN can of course also be effected by way of mail using a PIN letter if unique identification of the user with his address is possible. Unique identification of the customer with his address is always possible for example when the service operator is at the same time the mobile phone operator.

Instead of a separately transmitted PIN from the service operator, a PIN already associated with the mobile communication terminal can of course also be used, for example the PIN of the SIM card. This is expedient when this PIN is known to the service operator, i.e. in particular when the latter is the mobile phone operator. The use of an additional, separate PIN for utilizing the service increases security, however, since abuse of the method then not only presupposes unauthorized possession of the customer's mobile phone and knowledge of the associated PIN of the communication terminal, the unauthorized third party must furthermore know the service operator's additional PIN.

Transmission of the PIN to the mobile communication terminal can be effected as a text message, for example per SMS.

In a preferred embodiment of the method, the customer must first log into the service operator's computer network server from a computer, transmitting the identification feature stated at registration and/or the associated PIN. The service operator then checks the stated identification feature and/or PIN and enables further service only if the check was successful. The customer then makes a selection of goods from a goods from a merchant's range of goods. The selected goods are encrypted by the key and the encrypted goods transmitted to the customer's computer. Furthermore, the key is transmitted to the customer's mobile communication terminal as plaintext. The customer can then decrypt the goods by a decryption algorithm on the computer using the transmitted key.

The service operator need not necessarily be identical with the merchant. The merchant and the service operator should be contractual partners, however, and the service operator's server must have corresponding means for encrypting the selected goods for the customer and releasing them for downloading or for informing the merchant or the merchant's server that the customer is identified as authorized and his data are known to the service operator.

Since all data necessary for payment are known to the service operator and it is ensured that the downloaded goods, due to the encryption, can only be utilized by the authorized customer to whom the key has been transmitted, the amount to be paid can be easily collected by the service operator offline by a usual direct debiting method or the like (e.g. credit card). If service operator and merchant are not identical, corresponding clearing is effected.

It can also be provided that the user's computer sends an acknowledgement to the service operator or merchant after decryption has been effected. In this case it can also be provided that the amount to be paid is collected by the service operator only after said acknowledgement.

In an especially preferred method, the goods are personalized before transmission to the customer's computer. Personalization is effected with a unique ID, for example a so-called software “watermark.” Thus the goods are uniquely identifiable as belonging to the customer even after decryption. Personalization can preferably be effected on the basis of the identification feature deposited at registration, for example the user's mobile phone number or address. Personalization impedes unauthorized forwarding of goods to others insofar as the origin can be detected anytime.

It goes without saying that the buyer can also select a plurality of goods simultaneously. These goods are preferably then encrypted with a key jointly as a parcel and downloaded to the computer of the customer, who then decrypts the total parcel all at once. The key is preferably transmitted to the mobile communication terminal as a text message, for example per SMS, so that the customer can easily read the key off a display on the device. It is of course also possible to transmit the key to the customer's mobile phone as a speech message.

The program required for decryption can be available freely as downloadable software. It can also be transmitted together with the goods, or is transmitted to the customer at registration.

The total method of customer registration, transmission of identification numbers and keys, check of identification numbers and other identification features, encryption of goods and downloading can be effected in fully automatic fashion via a suitable computer, for example the service operator's server, on which a corresponding computer program is implemented.

The invention will be explained again hereinafter with reference to a concrete example.

Before a first purchase, the new customer initially registers with a service operator over the Internet. The new user is identified by entry of his mobile phone number. After all the customer's necessary data have been registered, the customer is automatically sent a PIN for utilizing the service to his mobile phone as a short message. This concludes registration.

For utilizing the service, the customer must then log into the operator's Internet server on a computer by means of the PIN over a safe channel (for example SSL). The PIN is then checked by the service operator and further service enabled if the check was successful.

The computer can be any computer the customer is using at the moment. It does not have to be a specially registered computer or a computer with a specially registered connection.

Then the customer can put together a digital shopping cart consisting of any digital or digitizable goods, such as documents, books, software or music files, at the desired Internet shop, which is a contractual partner of the service operator. The total digital shopping cart is then encrypted for the customer by a one-time key. The key is dependent on the particular customer and can be generated for example using the PIN or the other customer data. During encryption the goods are simultaneously personalized with a unique sign. The encrypted digital shopping cart is then downloaded to the customer's computer.

Simultaneously or after clarification of payment, the key used for encrypting the goods is transmitted to the customer as a plaintext key per SMS. The customer can read the key off the display of his mobile phone and decrypt the goods by inputting the key, for which purpose the customer can use software installed on the computer or an applet.

The inventive method is employable wherever the customer is reachable with his mobile communication terminal, i.e. also internationally wherever roaming is possible if a mobile phone is being used. No special infrastructure, such as a smart-card terminal, is required at the computer being used by the customer.

1. A method for protecting digital goods upon sale over a computer network whereby the goods are encrypted with a key using a symmetric encryption method, the encrypted goods are transmitted over the computer network to a customer's computer and decrypted there by the key, characterized in that the key is transmitted to the customer's mobile communication terminal over a mobile phone network.

2. A method according to claim 1, characterized in that the customer is registered with a service operator before a first purchase and thereby transmits an identification feature that is uniquely linked with the user's mobile communication terminal.

3. A method according to claim 2, characterized in that at registration the customer is assigned a personal identification number which is transmitted to the customer.

4. A method according to claim 3, characterized in that the personal identification number is transmitted to the customer's mobile communication terminal over a mobile phone network or to the customer by means of a letter.

5. A method according to any of claims 2 to 4, characterized by the following steps:
the customer logs into the service operator's computer network server from a computer while transmitting the identification feature stated at registration and/or the associated personal identification number,
the identification feature and/or associated personal identification number is checked,
the customer selects goods from a merchant's range of goods,
the selected goods are encrypted by the key,
the encrypted goods are transmitted to the customer's computer,
the key is transmitted to the customer's mobile communication terminal as plaintext,
the goods are decrypted by a decryption algorithm on the customer's computer using the transmitted key.

6. A method according to any of claims 1 to 5, characterized in that a plurality of goods are encrypted with one key jointly as a parcel.

7. A method according to any of claims 1 to 6, characterized in that the goods are personalized before transmission to the customer's computer.

8. A method according to claim 7, characterized in that personalization is effected using the identification feature transmitted to the service operator at registration of the customer.

9. A method according to any of claims 1 to 8, characterized in that the key is a one-time key.

10. A method according to any of claims 1 to 9, characterized in that the key is transmitted as a text or speech message.

11. A method according to any of claims 1 to 10, characterized in that after decryption of the goods by the customer using the transmitted key, an acknowledgement of successful decryption is sent to the service operator.

12. A computer program with program code means for executing all steps according to any of the above claims when the program is executed on a computer.

13. A computer program with program code means according to claim 12 that is stored in a computer-readable data memory.
